(19) United States
(12) Patent Application Publication
(10) Pub. No.: US 2017/0357770 A1
(43) Pub. Date: Dec. 14, 2017

(54) HEALTH RISK CLOUD ANALYSIS SYSTEM CAPABLE OF INTEGRATING GENE INFORMATION AND ACQUIRED LIFESTYLE

(71) Applicant: UNION APPLIED GENE INC., TAIPEI CITY (TW)

(72) Inventors: Hung-Wei SHU, TAIPEI CITY (TW); You-Wei LIN, TAIPEI CITY (TW); Fu-Yang CHUANG, TAIPEI CITY (TW); Li-Wei LIN, TAIPEI CITY (TW); Wei-Teng WENG, TAIPEI CITY (TW)

(21) Appl. No.: 15/182,562

(22) Filed: Jun. 14, 2016

(51) Int. Cl. G06F 19/00

(52) U.S. Cl. CPC G06F 19/3431; G06F 19/363

(57) ABSTRACT

A health risk cloud analysis system capable of integrating gene information and acquired lifestyle, includes: a cloud analysis server, a lifestyle assessment and questionnaire database, a client device, a gene detection system, a gene detection database, a client data and result report database, and a health improvement and advice analysis database. The health risk cloud analysis system is an overall health risk assessment method based on inborn gene information and acquired lifestyle data, and is capable of quickly and reliably analyzing health risk of multiple items, and providing precise overall personal health risk and improvement advice, so that users can fully understand their health risks. With appropriate and optimal health improvement advice and health products, the present invention is able to precisely and effectively improve health and prevent disease, which is helpful to improve the quality of life and reduce the waste of medical resources.

### BACKGROUND

### Field of the Invention

The present invention relates to a cloud analysis system, and more particularly to a health risk cloud analysis system capable of integrating gene information and acquired lifestyle, and providing precise overall personal health risk and improvement advice, so that users can fully understand their health risks.

### Related Prior Art

Gene detection technology has been developed for decades, with the rise of the concept of precise medicine, people start to pay more and more attention to preventive medicine. Genetic detection can help us to understand our natural constitutions and heath risks, which hopefully can achieve the goals of improving health and preventing disease. However, out health is not only determined by gene, but also greatly affected by acquired lifestyle. It will be difficult to precisely and reliably to reflect to the overall heath risk if the lifestyle is not taken into account when assessing health risk. The combination of inborn gene information and acquired lifestyle would ensure a more complete and comprehensive health assessment, which is helpful to improve the quality of life and reduce the waste of medical resources. With the big data analysis becoming more and more mature in recent years, real-time data processing and calculation in cloud starts to be applied in various fields. Currently, there is such a cloud analysis system which is capable of integrating gene information and acquired lifestyle, such system is essential for the future preventive medicine and personal medicine.

For example, Taiwan Patent No. I488050 discloses an “analysis module, cloud analysis system and method”, the analysis module includes an analysis unit and a database management system, the cloud analysis system includes a server and a client. The client uploads a data produced by a health measuring instrument to the server, through cloud computing and integration, the original data is turned into non-shock trend data which represents the personal overall physiological parameters, so that users can acquire personal health analysis through the cloud network.

Another Taiwan Patent No. I501185 discloses a “cloud analysis system and a grouping method based on heath information”. The cloud analysis system can receive data from user's equipments, the physiological sensing device at client end is provided with a communication device, which is capable of inputting personal health information and transmitting it to the group server where files for personal health information will be established. The files can be grouped based on health distances.

Using instruments to measure the user's health only can acquire the user's current physiological heath data in the current environment, which is only capable of seeking treatment or remedy for the defects that have been produced, in the aspect of pursuing tracking and improvement. The concept of grouping based on heath distance is quiet good, however, very few people are willing to talk about their health status in public or share with others, and there is a risk of personal privacy leakage. Besides, the current cloud health analysis systems are mainly based on the current physiological status, without inborn gene information integration analysis, and are therefore unable to provide appropriate and effective heath improvement advices and products, since there are various personal inborn constitutions.

The present invention has arisen to mitigate and/or obviate the afore-described disadvantages.

### SUMMARY

The present invention is aimed at providing a health risk cloud analysis system capable of integrating gene information and acquired lifestyle. The health risk cloud analysis system is an overall health risk assessment method based on inborn gene information and acquired lifestyle data, which is capable of quickly and reliably analyzing health risk of multiple items, and providing precise overall personal health risk and improvement advice, so that users can fully understand their health risks. With appropriate and optimal health improvement advice and health products, the present invention is able to precisely and effectively improve health and prevent disease, which is helpful to improve the quality of life and reduce the waste of medical resources.

Therefore, a health risk cloud analysis system capable of integrating gene information and acquired lifestyle in accordance with the present invention comprises: a cloud analysis server, a lifestyle assessment and questionnaire database, a client device, a gene detection system, a gene detection database, and a client data and result report database. The cloud analysis server is signal connected to the client device, the lifestyle assessment and questionnaire database, the gene detection database, and the client data and result report database, respectively, the cloud analysis server performs integrated analysis and management of data. The gene detection system is signal connected to the gene detection database, the gene detection system performs gene detection to obtain inborn information which is to be sent to and stored in the gene detection database. The lifestyle assessment and questionnaire database includes a plurality of lifestyle questions, so that, according to different test items, a user can login to the cloud analysis server to extract corresponding lifestyle questions through data comparison exchange with the lifestyle assessment and questionnaire database, so as to perform acquired lifestyle analysis and assessment, and consequently obtain acquired information. According to a user's account information, the cloud analysis server extracts and analyzes the inborn information stored in the gene detection database, and then further executes integration calculation of the inborn information and the acquired information to obtain a personal potential health risk data which is to be stored in the client data and result report database.

The present invention allows the user to login from outside and fill out the lifestyle questionnaire, and upload it to the cloud analysis server. Then, the user's inborn gene detection result and the acquired lifestyle assessment result are integrated and calculated, and the calculation result will be transmitted to the health improvement and advice analysis database to perform data exchange and comparison to obtain a precise overall personal health risk data and improvement advice. The health risk cloud analysis system is capable of quickly and reliably analyzing health risk of multiple items, and providing precise overall personal health risk and improvement advice, so that users can fully understand their health risks. With appropriate and optimal health improvement advice and health products, the present invention is able to precisely and effectively improve health and prevent disease.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

FIG. 1 is a block diagram of a health risk cloud analysis system capable of integrating gene information and acquired lifestyle in accordance with the preferred embodiment of the present invention;

FIG. 2 is a block diagram of a cloud analysis server of the health risk cloud analysis system in accordance with the preferred embodiment of the present invention;

FIG. 3 is a block diagram of a login page of the user interface of the health risk cloud analysis system in accordance with the preferred embodiment of the present invention;

FIG. 4 is a block diagram of a test item page of the user interface of the health risk cloud analysis system in accordance with the preferred embodiment of the present invention;

FIG. 5 is a block diagram of a lifestyle questionnaire page of the user interface of the health risk cloud analysis system in accordance with the preferred embodiment of the present invention; and

FIG. 6 is a block diagram of an analysis result page of the user interface of the health risk cloud analysis system in accordance with the preferred embodiment of the present invention.

### DETAILED DESCRIPTION

The present invention will be clearer from the following description when viewed together with the accompanying drawings, which show, for purpose of illustrations only, the preferred embodiment in accordance with the present invention.

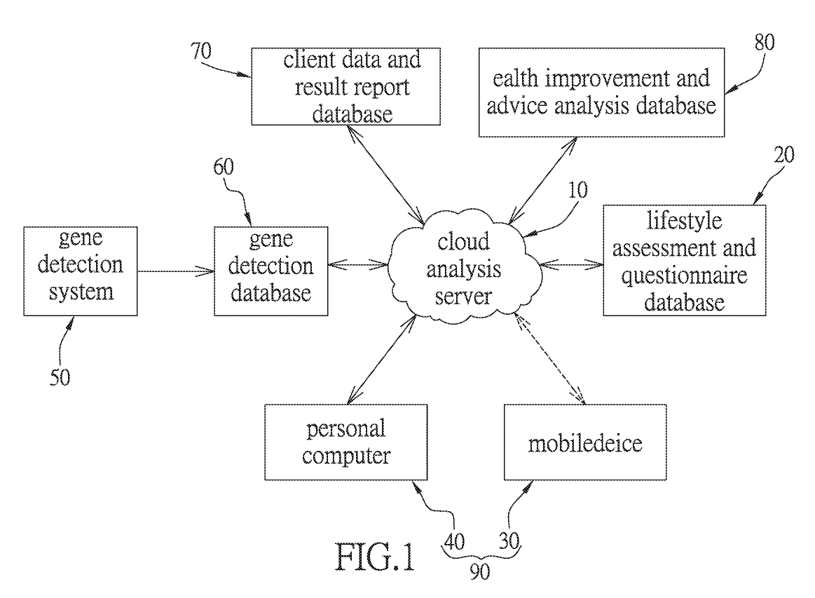

Referring to FIG. 1, a health risk cloud analysis system capable of integrating gene information and acquired lifestyle in accordance with the preferred embodiment of the present invention, comprises: a cloud analysis server 10, a lifestyle assessment and questionnaire database 20, a client device 90, a gene detection system 50, a gene detection database 60, a client data and result report database 70, and a health improvement and advice analysis database 80. The cloud analysis server 10 is signal connected to the lifestyle assessment and questionnaire database 20, the gene detection database 60, the client data and result report database 70, the health improvement and advice analysis database 80 and the client device 90.

In this embodiment, the client device 90 can be a mobile device 30 or a personal computer 40. The user can access the cloud analysis server 10 wirelessly via the mobile device 30 or wirelessly or wirely via the personal computer 40. As a data interactive computing and transmission center, the cloud analysis server 10 servers to perform data integration analysis and management control. The gene detection system 50 can be connected to the gene detection database 60 in a wireless manner or through wired network, so that detection result can be transmitted to and stored in the gene detection database 60, and then the cloud analysis server 10 can access the gene detection results to analyze the inborn constitution of the client.

The lifestyle assessment and questionnaire database 20 includes a plurality of lifestyle questions. The user can login to the cloud analysis server 10 via the mobile device 30 or the personal computer 40. Based on different detection or test items, the user, after login, can extract corresponding lifestyle questions through the data comparison exchange with the lifestyle assessment and questionnaire database 20, so as to perform acquired lifestyle analysis and assessment, and consequently obtain acquired information.

The gene detection system 50 can carry out gene detection and test, and synchronize the detection data to the gene detection database 60. The gene detection data is defined as inborn information. The cloud analysis server 10 will access the inborn information from the gene detection database 60, according to the user's account information, to perform analysis of the inborn constitution, and then further execute integration calculation of the inborn information and the acquired information to obtain a personal potential health risk data.

The cloud analysis server 10 will further exchange data with the health improvement and advice analysis database 80 to perform interactive analysis of the personal potential health risk data, so as to obtain a personal health risk and improvement advice.

The cloud analysis server 10 will extract and integrate the personal health risk and improvement advice with related client's information, then structurize the data and store it in the client data and result report database 70, which allows the users to browse through reports in the cloud to understand their personal potential health risk. With appropriate and optimal health improvement advice and health products, the present invention is able to precisely and effectively improve health and prevent disease.

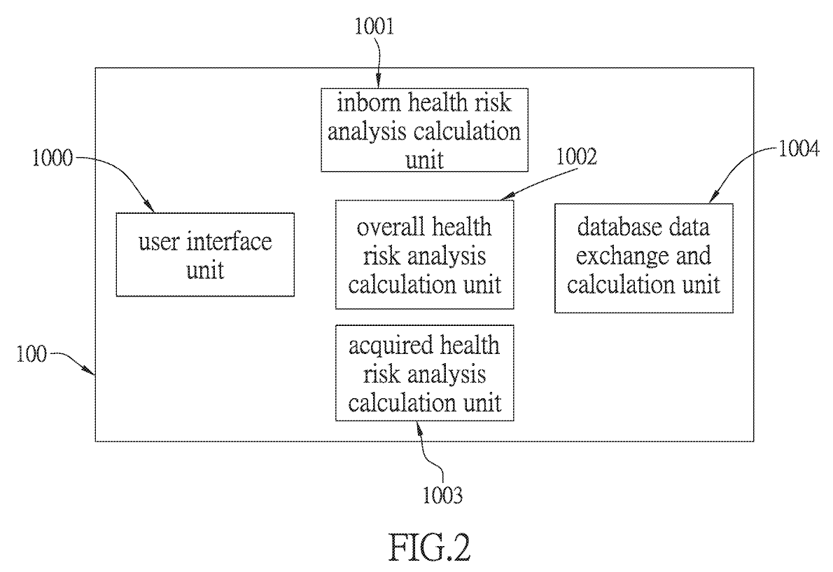

Referring then to FIG. 2, the cloud analysis server 10 includes five key calculation and application units, which are: a user interface unit 1000, an inborn health risk analysis calculation unit 1001, an overall health risk analysis calculation unit 1002, an acquired health risk analysis calculation unit 1003 and a database data exchange and calculation unit 1004. The user interface unit 1000 is a management interface allowing for wire or wireless access to the cloud server. Users can read the relative information about user's account and test products, to answer or fill out the lifestyle questionnaire and perform health risk cloud analysis. With the user's account and the test product information, the inborn health risk analysis calculation unit 1001 can extract the corresponding inborn information stored in the gene detection database 60 via the database data exchange and calculation unit 1004, then perform analysis of gene detection results to obtain an inborn health risk calculation result. With the user's account and the test product information, the acquired health risk analysis calculation unit 1003 can extract corresponding lifestyle questions stored in the data comparison exchange of the lifestyle assessment and questionnaire database 20, via the database data exchange and calculation unit 1004, and then performs lifestyle assessment based on the user's answers to the questionnaire, so as to obtain the inborn information. The overall health risk analysis calculation unit 1002 can integrate the inborn health risk and the acquired information, and perform systematic calculation based on different test products, so as to obtain a comprehensive and reliable health risk analysis data, then the calculation result is structurized by the database data exchange and calculation unit 1004 and stored in the client data and result report database 70. With the user's account and the test product information, the database data exchange and calculation unit 1004 can perform interactive analysis linked to respective databases, provide efficient data exchange and analysis for respective calculation units, thus improving the execution capability of the real-time cloud analysis.

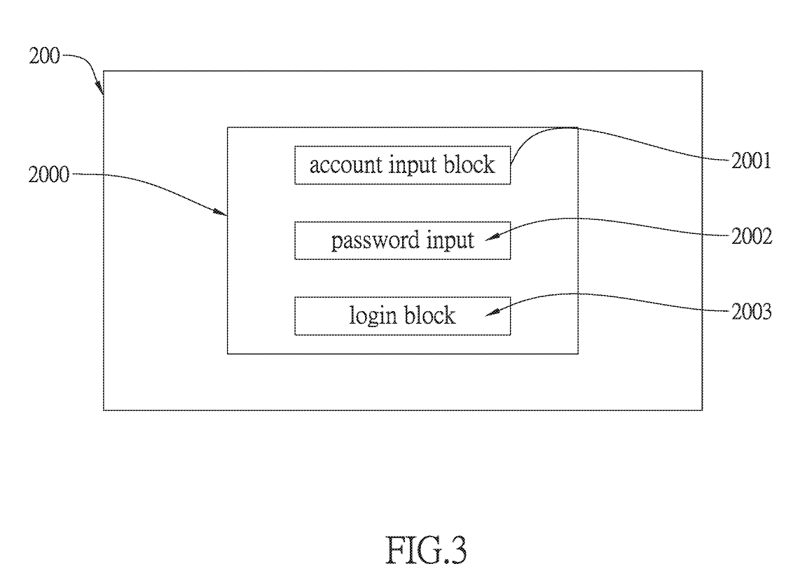

The user can use a simple and safety management interface to login to the cloud analysis server 10 wireless via the mobile device 30 or wirelessly or wirely via the personal computer 40. As shown in FIG. 3, a login page 200 of a user interface of the cloud analysis system is secured with SSL (secure sockets layer) to provide the user a secure data transmission interface. A user interactive login block 2000 on the login page 200 includes an account input block 2001, a password input block 2002, and a login block 2003. In addition to providing login options, the login block 2003 also provides password acquiring options which allow a user who forgets password to get the password back through short message or Email.

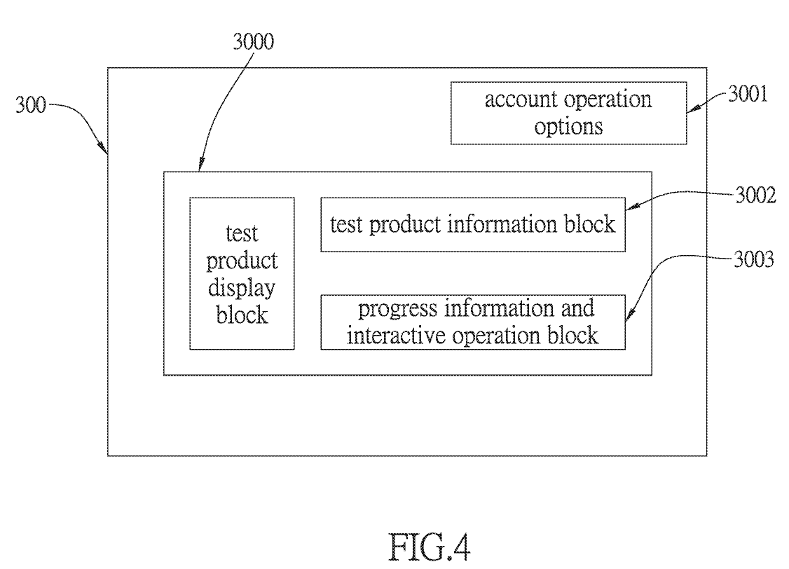

After the user logins, the test product information will be acquired and displayed based on the account data. In addition to letting the user know the progress of the completion of the test, the lifestyle assessment and health risk cloud analysis can also be carried out. As shown in FIG. 4, a test item page 300 of the user interface is secured with SSL to provide the user a secure data assess interface, and includes a test product display block 3000, account operation options 3001, a test product information block 3002, and a progress information and interactive operation block 3003. The test product display block 3000 varies with the variation of the user's test projects, the test projects include, but not limited to: obese, antioxidant capacity, immune regulation, liver's detoxification capability, aging, skin, lifestyle related diseases, cancer, and etc. If the user is tested for more than two items, the test product display block 3000 will be presented in plural form. The account operation options 3001 allows the user to browse through and modify the personal data of the account, such as the change of telephone number, address, email, and password. The test product information block 3002 will illustrate the overview of the content of the test item, including the user's test number, submission date, completion date, and etc. The progress information and interactive operation block 3003 will show the progress of completion of the test item. For example, if the gene detection or test is not finished, there is no gene detection result data in the gene detection database 60, it will be unable to carry out lifestyle questionnaire and the overall heath risk cloud analysis. The option for health risk analysis appears only when the gene detection is finished, then the lifestyle questionnaire page can be assessed, and then the overall health risk analysis is allowed to be carried out.

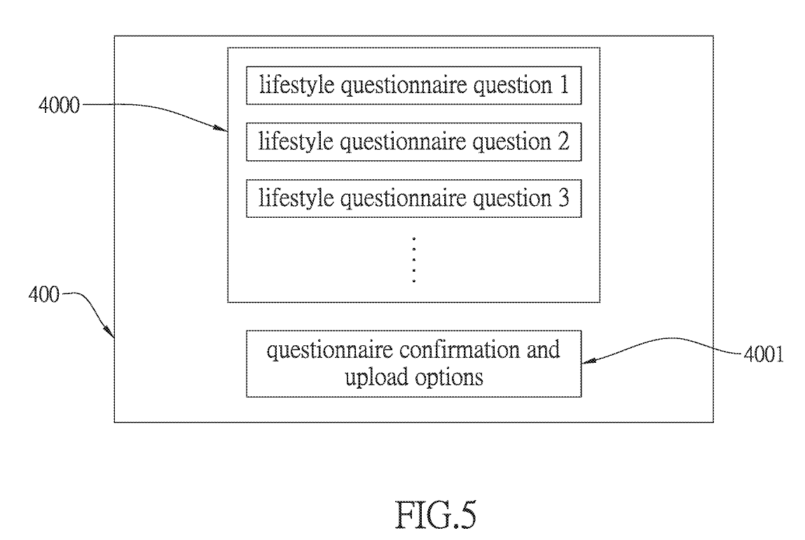

After completion of the gene detection, the user can assess a lifestyle questionnaire page 400 via the test item page 300 of the user interface, to complete the acquired health risk calculation and the real-time cloud analysis of the overall health risk. As shown in FIG. 5, when the gene detection is finished, the gene detection result data will be transmitted from the gene detection system 50 to the gene detection database 60. At this moment, the overall health risk cloud analysis can be fulfilled by answering or filling out the lifestyle questionnaire. The user can assess the lifestyle questionnaire page 400 via the progress information and interactive operation block 3003 of the test item page 300 of the user interface. The lifestyle questionnaire page 400 uses SSL to provide a secure questionnaire page, which includes: lifestyle questionnaire question block 4000, questionnaire confirmation and upload options 4001. The lifestyle questionnaire question block 4000 will extract corresponding questions from the lifestyle assessment and questionnaire database 20 according to the user's test items. After completion of the questionnaire, the user can upload the answer to the cloud analysis server 10 via the questionnaire confirmation and upload options 4001, to calculate the acquired health risk, and further perform comprehensive and reliable overall health risk real-time cloud analysis based on the personal potential health risk data obtained from the gene detection results.

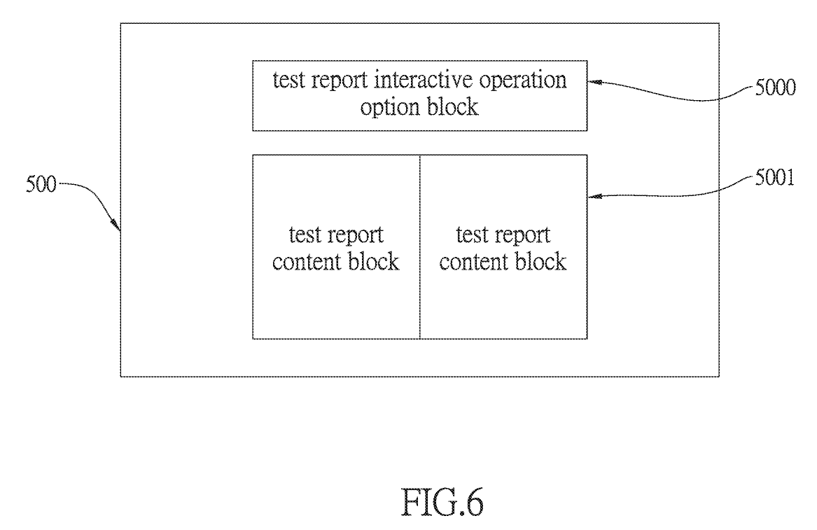

The cloud analysis server 10 will further exchange data with the health improvement and advice analysis database 80 to perform interactive analysis of analyzed health risk data, so as to obtain a precise overall personal health risk data and improvement advice. As shown in FIG. 6, after the health improvement and advice analysis database 80 performs data exchange analysis to obtain personalized result report, the analysis result and report information will be structurized and stored in the client data and result report database 70. The user can download the analysis report to the mobile device 30 or the personal computer 40 via the progress information and interactive operation block 3003 of the test item page 300 of the user interface. Or, the user can assess an analysis result report page 500 of the user interface to directly browse through the cloud reports. The analysis result report page 500 uses SSL to secure the user's personal data, and includes: test report interactive operation option block 5000, and test report content block 5001. The test report interactive operation option block 5000 provides a function of report interactive operation, such as: printing, overview, zoom, page up/down, automatic page turning, share, and etc, to enhance the user's experience of report reading. The test report content block 5001 presents the content of the analysis report in the form of a book. In addition to increasing readability, it also makes the cloud report closer to the user's life.

To sum up, the health risk cloud analysis system capable of integrating gene information and acquired lifestyle in accordance with the preferred embodiment of the present invention is an overall health risk assessment method based on inborn gene information and acquired lifestyle data, which is capable of quickly and reliably analyzing health risk of multiple items, and providing precise overall personal health risk and improvement advice, so that users can fully understand their health risks. With appropriate and optimal health improvement advice and health products, the present invention is able to precisely and effectively improve health and prevent disease, which is helpful to improve the quality of life and reduce the waste of medical resources.

While we have shown and described various embodiments in accordance with the present invention, it is clear to those skilled in the art that further embodiments may be made without departing from the scope of the present invention.

What is claimed is:

1. A health risk cloud analysis system capable of integrating gene information and acquired lifestyle, comprising: a cloud analysis server, a lifestyle assessment and questionnaire database, a client device, a gene detection system, a gene detection database, and a client data and result report database; wherein:
the cloud analysis server is signal connected to the client device, the lifestyle assessment and questionnaire database, the gene detection database, and the client data and result report database, respectively, the cloud analysis server performs integrated analysis and management of data;
the gene detection system is signal connected to the gene detection database, the gene detection system performs gene detection to obtain an inborn information which is to be sent to and stored in the gene detection database;
the lifestyle assessment and questionnaire database includes a plurality of lifestyle questions, so that, according to different test items, a user can login to the cloud analysis server to extract corresponding lifestyle questions through data comparison exchange with the lifestyle assessment and questionnaire database, so as to perform acquired lifestyle analysis and assessment, and consequently obtain acquired information;
according to a user's account information, the cloud analysis server then extracts and analyzes the inborn information stored in the gene detection database, and then further execute integration calculation of the inborn information and the acquired information to obtain a personal potential health risk data which is to be stored in the client data and result report database.

2. The health risk cloud analysis system as claimed in claim 1 further comprising a health improvement and advice analysis database signal connected to the cloud analysis server, the cloud analysis server exchanges data with the health improvement and advice analysis database to perform interactive analysis of the personal potential health risk data, so as to obtain a personal health risk and improvement advice which is to be stored in the client data and result report database.

3. The health risk cloud analysis system as claimed in claim 1, wherein the client device is a mobile device or a personal computer, the mobile device is signal connected to the cloud analysis server in a wireless manner, and the personal computer is signal connected to the cloud analysis server in a wire or wireless manner.

4. The health risk cloud analysis system as claimed in claim 2, wherein the client device is a mobile device or a personal computer, the mobile device is signal connected to the cloud analysis server in a wireless manner, and the personal computer is signal connected to the cloud analysis server in a wire or wireless manner.

5. The health risk cloud analysis system as claimed in claim 1, wherein the cloud analysis server includes: a user interface unit, an inborn health risk analysis calculation unit, an overall health risk analysis calculation unit, an acquired health risk analysis calculation unit and a database data exchange and calculation unit;
the user interface unit is a management interface;
the database data exchange and calculation unit serves to extract the corresponding inborn information stored in the gene detection database, and extract corresponding lifestyle questions stored in the data comparison exchange of the lifestyle assessment and questionnaire database;
the acquired health risk analysis calculation unit performs assessment to obtain the inborn information, based on the user's account information and user's answers to the questionnaire;
the inborn health risk analysis calculation unit performs analysis of gene detection results to obtain an inborn health risk calculation result, based on the user's account information and the inborn information; and
the overall health risk analysis calculation unit structurizes the acquired information and the inborn health risk calculation result to produce the personal potential health risk data which is to be stored in the client data and result report database.

6. The health risk cloud analysis system as claimed in claim 2, wherein the cloud analysis server includes: a user interface unit, an inborn health risk analysis calculation unit, an overall health risk analysis calculation unit, an acquired health risk analysis calculation unit and a database data exchange and calculation unit;
the user interface unit is a management interface;
the database data exchange and calculation unit serves to extract the corresponding inborn information stored in the gene detection database, and extract corresponding lifestyle questions stored in the data comparison exchange of the lifestyle assessment and questionnaire database;
the acquired health risk analysis calculation unit performs assessment to obtain the inborn information, based on the user's account information and user's answers to the questionnaire;
the inborn health risk analysis calculation unit performs analysis of gene detection results to obtain an inborn health risk calculation result, based on the user's account information and the inborn information; and
the overall health risk analysis calculation unit structurizes the acquired information and the inborn health risk calculation result to produce the personal potential health risk data which is to be stored in the client data and result report database.

7. The health risk cloud analysis system as claimed in claim 5, wherein the client device is a mobile device or a personal computer, the mobile device is signal connected to the cloud analysis server in a wireless manner, and the personal computer is signal connected to the cloud analysis server in a wire or wireless manner.

8. The health risk cloud analysis system as claimed in claim 6, wherein the client device is a mobile device or a personal computer, the mobile device is signal connected to the cloud analysis server in a wireless manner, and the personal computer is signal connected to the cloud analysis server in a wire or wireless manner.
